(19) United States
(12) Patent Application Publication
(10) Pub. No.: US 2026/0046308 A1
(43) Pub. Date: Feb. 12, 2026

(54) PREVENTING SUPERVISION FRAME INJECTION ATTACKS IN REPLICATION NETWORKS

(71) Applicant: Cisco Technology, Inc., San Jose, CA (US)

(72) Inventors: Saravanan M Karunanidhi, Bangalore (IN); Priyanka Bansal, Bangalore (IN); Robert Edgar Barton, Richmond (CA)

(21) Appl. No.: 18/798,745

(22) Filed: Aug. 8, 2024

(51) Int. Cl. H04L 9/40

(52) U.S. Cl. CPC H04L 63/1466; H04L 63/08

(57) ABSTRACT

Disclosed are systems, apparatuses, methods, and computer-readable media for preventing supervision frame injection attacks in replication networks. A method includes: identifying, by a network device, a trusted network device in a replication network; providing credentials to the trusted network device to validate an identity of the network device; based on authentication of the credential at the trusted network device, receiving security information from the trusted network device that is encrypted with a public key of the network device; and transmitting an onboarding supervision frame encrypted with or signed by the security information, wherein a management device of the replication network updates a trusted peer information based on the onboarding supervision frame.

### TECHNICAL FIELD

The disclosure relates generally to cloud networking and, more specifically but not exclusively, to systems and techniques for preventing supervision frame injection attacks in replication networks.

### BACKGROUND

Replication networks are implemented across various industries to ensure high reliability and minimal downtime in critical systems. In industrial automation, High-availability Seamless Redundancy (HSR) is used to maintain continuous operation by providing redundant data transmission paths. Power substation networks often utilize Parallel Redundancy Protocol (PRP) to manage crucial data, enhancing communication system reliability. Telecommunication providers, financial trading systems, data centers, and cloud services all rely on replication networks to maintain service continuity, data integrity, and customer trust. Additionally, public safety communication networks and transportation control systems, such as those in aviation and railways, implement replication networks to ensure operational safety and efficiency during emergencies or network failures. These implementations highlight the importance of replication networks in maintaining consistent and reliable data flow across diverse applications.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a High-availability Seamless Redundancy (HSR) network in accordance with some aspects of the disclosure;

FIG. 2 is a block diagram of a Parallel Redundancy Protocol (PRP) network in accordance with some aspects of the disclosure;

FIG. 3 is a block diagram illustrating a network device for preventing supervision frame injection attacks in replication networks in accordance with some aspects of the disclosure;

FIG. 4 illustrates an example method for preventing supervision frame injection attacks in replication networks in accordance with some aspects of the disclosure;

FIG. 5 is a sequence diagram for preventing supervision frame injection attacks in replication networks in accordance with some aspects of the disclosure;

FIG. 6 illustrates an example method for preventing supervision frame injection attacks in replication networks in accordance with some aspects of the disclosure;

FIG. 7 illustrates a block diagram of a system-on-chip (SoC) used in a network device to perform various functions in hardware in accordance with various aspects of the disclosure; and

FIG. 8 shows an example of a computing system, which may be for example any computing device that may implement components of the system.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Overview

Certain applications, such as television studios, utilities, manufacturing facilities, and other real-time control applications (e.g., real-time conferencing applications) may require a demand for ultra-low packet loss rates. The applications may include, for example, but not limited to deterministic networks, such as those used with virtual private networks and may require ultra-low packet loss rates (e.g., loss rates ranging from 10⁻⁶ to 10⁻¹² or potentially even lower).

Packet loss may be defined in two non-limiting categories: single failures and availability failures. Single failures may, for example, affect a single or only a few packets per failure event. Congestion is one cause for such single failures resulting in packet loss. Congestion may occur on wired networks when a forwarding node (bridge, router, or other non-limiting network device) lacks sufficient buffer memory space to accommodate a received packet for subsequent forwarding. When the network device lacks such buffer space, the received packet may have to be dropped and does not continue on the path to the desired destination.

In such a wired network scenario, the transmission rate may be limited by any number of random events. Random events may occur in the medium or the forwarding devices themselves and include, for example, cosmic rays, power fluctuations, electromagnetic interference, and other rate-limiting events.

Alternatively, availability failures may occur when there is a failure of a network device (node), an individual component of the network device, or a failure of the transmission medium itself that may render the particular network device unable to forward packets. Depending on the severity of the availability failure, the network device may be unable to forward packets from a period consisting of a matter of seconds to a matter of days or more.

As described herein, the availability and single failure that are described are non-limiting examples, and failures at intermediate rates are also possible. For example, failures at intermediate rates may be handled in some embodiments by various heuristics that can identify excessive single failures, and in some cases subsequently trigger a purposeful availability failure.

Approaches to achieve ultra-low packet loss may include the concept of simple multipathing. In simple multipathing, the same data packet traveling to a destination is sent on more than one path from the source to the destination. Ideally, the multipathing may send the same packet (original and replicated) on separate paths in a near-simultaneous manner. Extra copies of the packet received at the destination may be subsequently discarded. In various embodiments, a network forwarding device located near the source of the packet may be responsible for replicating packets to be sent to the destination. Similarly, a network device located near the destination may be responsible for deleting received duplicate packets.

A replication network is a network designed to ensure data redundancy and availability by copying and maintaining data across multiple parallel paths in different nodes. Based on the duplicate paths, a replication network enhances data reliability, fault tolerance, and disaster recovery capabilities by synchronizing replicas of data transmitted along each path. In the event of a failure or data loss at a single node, the replication network allows access to the same data from a different network, minimizing downtime and ensuring continuous operation. Replication networks are used for applications that cannot withstand packet loss such as utility applications (e.g., electrical grid, water, etc.), industrial applications (e.g., factory automation), transportation systems (e.g., rail systems, autonomous driving, etc.), health systems, and so forth.

One type of replication network is a Parallel Redundancy Protocol (PRP) network, which uses Ethernet connections that provide seamless failover against failure of any network component. A PRP uses multiple local area networks (LANs) to duplicate traffic along independent paths to ensure fault tolerance. Another type of replication network is High-availability Seamless Redundancy (HSR) network. An HSR network consists of a ring topology using dual attached nodes. Frames are sent in both directions along the ring, and removed at different nodes along the rings once determined that the frame has been successfully forwarded to the destination outside of the ring.

In the case of high-speed streams (i.e. real-time applications), the duplicate replication frame elimination function requires detailed history keeping, adding another undesired level of complexity to the design of each network device. The use of the stream sequence numbers may make it very difficult to create a solution that works for paths that are both bridged and routed, by requiring an L2 tag with information that does not get routed and an L3 encapsulation of that same information which is not easily visible to bridge devices. For this reason, replication networks choose a dominant network and default forward frames from the dominant network unless there is a failure within the dominant network.

Replication networks may use a supervisor frame (also referred to as a supervision or a supervisory frame) which is a specific type of data frame to control and supervise functions in the replication, often related to signaling, train control systems, and other critical operations. Supervisor frames are used to monitor the health and status of the replication network and carry information about the operational status of each node and the integrity of the network links, as well as the configuration of the network (e.g., joining the replication network). Supervisor frames also provide redundancy management of the duplicate path by ensuring both paths are actively being used and checked, as well as detect errors in the network, such as lost or corrupted frames. Supervisor frames may also provide status information about each node in the network such as an operational state of each node, any detected faults, synchronization information, and path verification. Supervisor frames also ensure that each node is aware of the network configuration and are used in adding new nodes, removing faulty ones, and updating the network map as changes occur. In some cases, the supervisor frame also ensures synchronization across the network to maintain data integrity and communication consistency.

A frame and a packet are both units of data transmission in computer networks, but they operate at different layers of the OSI model. A frame exists at the Data Link layer (Layer 2) and includes the payload data and also headers and trailers that contain control information such as error checking and the physical addresses of the source and destination devices. In contrast, a packet exists at the Network layer (Layer 3) and contains the payload along with a header that includes logical addressing information, such as IP addresses, which facilitates routing the data across different networks. Frames are transmitted of a physical link (e.g., a LAN segment) whereas packets are transmitted within the frames. Frames are used for data transmission within local network segments, packets are used to route data between different network segments, enabling communication across larger and interconnected networks.

Supervisor frames are critical for maintaining the integrity and functionality of replication networks (also referred to as redundancy networks). Supervisor frames provide supervision by constantly checking the presence and status of the nodes within the different paths and identifying which devices are Dual Attached Nodes (DANs), their medium access control (MAC) addresses, and their operating mode, which could be either duplicate accept or duplicate discard. This information assists a Link Redundancy Entity (LRE) in building a database, often referred to as a Node Table, which allows a network node to make decisions about duplicate generation and discard.

Supervisor frames have little to no security. If a malicious actor injects malicious supervisor frames into the network, either by compromising a PRP node or by falsely declaring itself as a PRP node, the malicious actor can cause significant disruption to the network. Misconfigured nodes may also produce supervisor frames which may cause network disruption. This can lead to unnecessary traffic or even affect the flow of data towards the Single Attached Nodes (SANs). For example, if a listener node is a listener and a malicious actor constantly injects a supervisor frame for the listener node on LAN-A, each PRP node may incorrectly update its database marking this node as DANP. The outcome will be detrimental to the PRP network because when traffic comes to a replication node, it will be incorrectly replicated on both networks (e.g., LAN-A and LAN-B) when it is not required or expected. In another case, malicious actors may inject supervision frames from many MAC addresses (e.g., thousands) with the intent of overwhelming the Node Table, which can exceed the supported limit and render the entire system useless.

Systems, apparatuses, processes (also referred to as methods), and computer-readable media (collectively referred to as “systems and techniques”) are described herein for preventing supervision frame injection attacks in replication networks. In some aspects, a chain of trust is established based on a trust anchor node. The trust anchor node generates security information that enables communication of a supervisor frame within the replication network based on the security information. The trusted node can enroll other peer nodes based on mutual authentication using security credentials and a remote attestation.

An example method includes identifying, by a network device, a trusted network device in a replication network; providing credentials to the trusted network device to validate an identity of the network device; based on authentication of the credential at the trusted network device, receiving security information from the trusted network device that is encrypted with a public key of the network device; and transmitting an onboarding supervision frame encrypted with or signed by the security information, wherein a management device of the replication network updates trusted peer information based on the onboarding supervision frame.

Various aspects of the application will be described with respect to the figures.

### EXAMPLE EMBODIMENTS

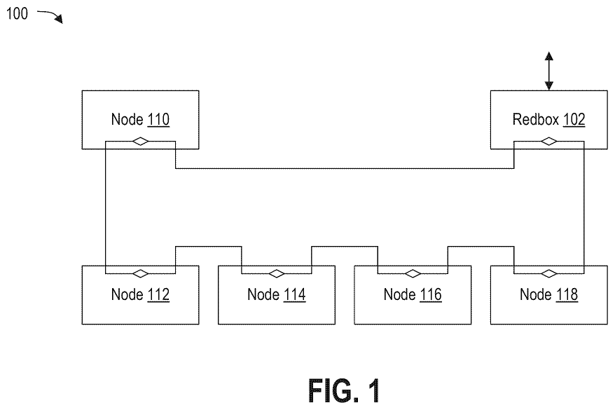

FIG. 1 is a block diagram of an HSR network 100 in accordance with some aspects of the disclosure. The HSR network 100 includes a redundancy box 102 (e.g., redbox) that is configured to handle supervisor frames and transmission of replicated data across a ring formed by the redundancy box 102 and node 110, node 112, node 114, node 116, and node 118. In this case, each node is dual attached to form a ring topology. In the event a frame is received by the redundancy box 102, the redundancy box 102 transmits replication frames on both network interfaces in the clockwise direction and the counterclockwise direction. Replication frames have a sequence identifier (e.g., a 16-bit value) to identify the frame. In the event a node is unavailable or otherwise slow, the replication frame will continue to have a low latency link to the destination. For example, in the event that a network link to the node 110 is congested or temporarily slow, a replication frame transmitted in the counterclockwise direction may be delayed. However, a replication frame transmitted by the redundancy box 102 in the clockwise direction can still reach node 112 irrespective of the path in the counterclockwise direction.

Once a replication frame is received by the destination node (e.g., node 112), the node 112 must maintain some type of infrastructure to handle the replication frame in the counterclockwise direction. In an HSR network, there are different methods to configure addressing the replication frame, such as sending an instruction to node 110 to drop the replicated frame. However, the node 110 must track the replication frames not received by node 112. Because Layer 2 operates at the hardware level, memory is limited and the link between redundancy box 102 and node 110 is unavailable for a long period of time (e.g., 10 seconds), the node 110 may have to drop replicated frame information and the sequence number may have wrapped around (e.g., starts over when a maximum number is reached) at the redundancy box 102, which can cause a reordering problem, which can cause frames to be dropped due to an ambiguity in the replicated frames.

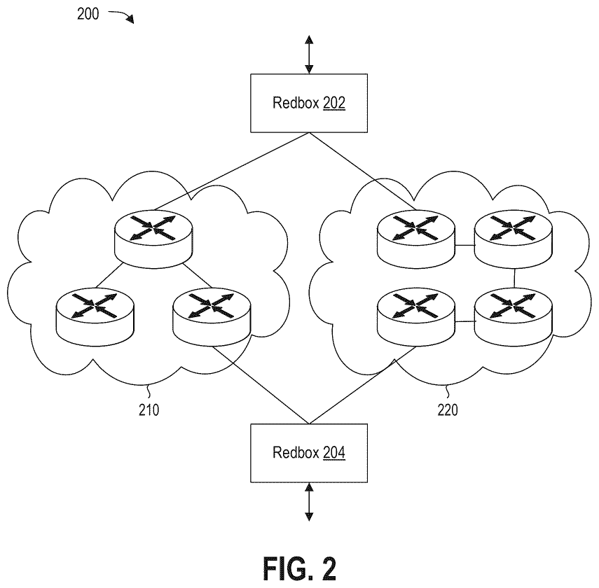

FIG. 2 is a block diagram of a PRP network 200 in accordance with some aspects of the disclosure. The PRP network 200 has a different topology than an HSR network (e.g., the HSR network 100 in FIG. 1) and includes a first redundancy box 202 and a second redundancy box 204. The first redundancy box 202 and the second redundancy box 204 are attached via redundant networks that can have different network topologies. For example, the second redundancy box 204 and the second redundancy box 204 are connected via a first network 210 and a second network 220.

The first network 210 and the second network 220 have different topologies and implementations, different ingress and egress points, and many different factors that make performance different. For example, the first network 210 has two node hops from the first redundancy box 202 to the second redundancy box 204, and the second network 220 has four node hops from the first redundancy box 202 to the second redundancy box 204. In this case, presuming at the network equipment and structure of the first network 210 and the second network 220 are similar, the first network 210 should have lower latency than the second network 220. However, the second network 220 may have an optimized structure, more modern equipment and configurations, and other differences that may decrease the latency and jitter through the second network 220.

In the event that the second redundancy box 204 is configured to perform deduplication of replicated frames provided from the first network 210 and the second network 220, the second redundancy box 204 tracks the different frames and ensures that both replicated frames are received. For example, if a replicated frame is received via the first network 210 and is not received via the second network 220, a link in the second network 220 may have failed. However, as the first network 210 and the second network 220 have different topologies, one of the networks may be slower and the second redundancy box 204 will need to buffer replicated frames that have not yet been received from the duplicate path. When both replicated frames are received, the frame can be forwarded from the second redundancy box 204.

The second redundancy box 204 therefore also has to track a last deduplicated frame and maintain replicated frames that are not yet received from the duplicate path. In the event that the second network 220 experiences a significant delay, such as a brownout that causes significant congestion in a particular link or node, the replicated frames from the second network 220 can be delayed. As the second redundancy box 204 needs to buffer all replicated frames that have not yet been deduplicated, in some cases, the second redundancy box 204 may exhaust its memory capacity since the frames and corresponding operations are performed in hardware. For example, the sequence number can wraparound and begin again, and as the second redundancy box 204 has dropped replicated frames, may cause frame loss.

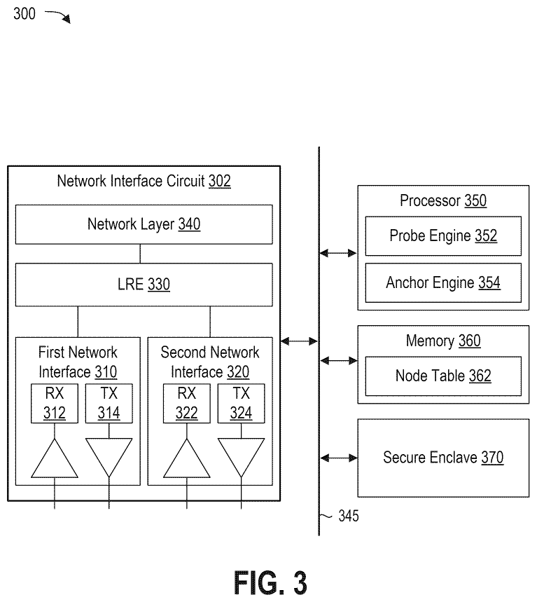

FIG. 3 is a block diagram illustrating a network device 300 for preventing supervision frame injection attacks in replication networks in accordance with some aspects of the disclosure. The network device 300 includes a network interface circuit 302 that is configured to interface with first network interface 310 and a second network interface 320. The network interface circuit 302 also includes an LRE 330 for processing frames and a network layer 340 for processing packets. The first network interface 310 is connected to a first network (e.g., the first nodes) and includes a receive circuit 312 and a transmit circuit 314 for providing access to the physical interface. The second network interface 320 is connected to a second network (e.g., the second nodes) and includes a receive circuit 322 and a transmit circuit 324 for providing access to the physical interface. The LRE 330 is configured to perform link redundancy functionality using the first network interface 310 and the second network interface 320. The LRE 330 may include a logic circuit configured to receive frames from the first network interface 310 or the second network interface 320 and process the frames in the order received.

The network interface circuit 302 also includes a bus 345 or other system interconnect for communication with other components in the network interface circuit 302. For example, the bus 345 allows the network interface circuit 302 to interface with a processor 350, a memory 360, and a secure enclave 370. The network interface circuit 302 accesses the other components via software interface, such as from the network layer 340. For example, the network layer 340 or the LRE 330 can process the frames (e.g., via an embedded processor within the network interface circuit 302) and provide packets reconstructed from the frames, or other signals and content that is pertinent to the Layer 2 networks.

In some aspects, supervisor frames transmitted in a replication network can be processed by the LRE 330 or the network layer 340, and then a software interrupt can be invoked to process the supervisor frame in the software domain. For example, the processor 350 can be configured to include a probe engine 352 for sending and receiving frames within the Layer 2 network using the network interface circuit 302. The processor 350 can also be configured to include an anchor engine 354 for providing and receiving trust to other Layer 2 devices within the replication network. Although the processor 350 is illustrated as being separate from the network interface circuit 302, the functionality pertaining to the probe engine 352 and the anchor engine 354 could also be handled within a processor associated with the network interface circuit 302.

The memory 360 can store data pertaining to the operation of a replication network and includes a node table 362.

A node table 362 is essential for managing and tracking the participating devices to ensure seamless communication and redundancy. A node table includes several components such as the node identifier (ID), a unique identifier for each node often represented by a MAC address or a specific node number, a human-readable node name for easy identification and management, a Node Status indicating the current status of the node (e.g., active, inactive, or error state), and details about the primary and secondary interfaces of the node. The node table 362 manages and monitors the devices within the network, ensuring robust communication and fault tolerance. The node table contains essential information such as unique identifiers (node identifiers), human-readable names (node names), current statuses (node statuses), and interface details for each node. For example, the node table 362 facilitates quick detection and recovery from link or device failures to enhance network reliability, redundancy, and performance.

The secure enclave 370 may be included in the network interface circuit 302 to protect sensitive data and computations from unauthorized access, even if the main operating environment of the network interface circuit 302 is compromised. Non-limiting examples of a secure enclave include a trusted platform module (TPM), a trusted anchor module (TAM), and so forth. The secure enclave 370 is a hardware-based isolated execution environment that encrypts and decrypts data within the enclave, ensuring that the data remains secure during processing. The secure enclave 370 uses unique keys and cryptographic techniques to verify and protect the integrity of the data and the code running inside. Security provided by the secure enclave 370 enhances security in various applications, such as protecting encryption keys, secure transactions, and sensitive personal information to mitigate the risk of data breaches and cyberattacks. For example, the secure enclave 370 can be used to authenticate and validate information from other devices, such as attestation. Attestation is a security process in which a device (e.g., the 302) proves its integrity and authenticity to a remote verifier by providing cryptographic evidence that the software and hardware configurations are untampered and trustworthy. The attestation process ensures that the environment of the network interface circuit 302 is secure and proves its identity before allowing sensitive operations or data exchanges.

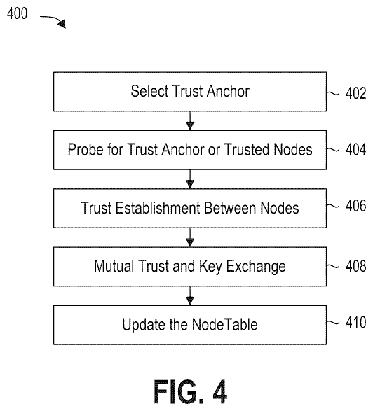

FIG. 4 illustrates an example method 400 for establishing trust in a replication network to prevent frame injection attacks in accordance with some aspects of the disclosure.

At block 402, a trust anchor associated with nodes of a replication network is selected as a trust anchor (or trust anchor). In some aspects, the trust anchor is responsible for selecting a redundancy network key, which may be an asymmetric key pair and may also be referred to as a RedNetKey. The trust anchor is further configured to provide onboarding of other peer nodes in the replication network and distributing the redundancy network key to other nodes. The redundancy network key is used to at least validate other nodes to ensure that the network traffic is valid. In this manner, a malicious node cannot request access to the replication network and then send supervision frames with unauthorized content. In some aspects, the trust anchor can also enroll other nodes to onboard other peer nodes by further distributing the redundancy network key. That is, the nodes provide a hierarchal distribution to allow onboard other peers within the first hop to reduce the load on the trust anchor itself.

In some aspects, the trust anchor node can be selected based on configuration or can be done by automatic selection in the network and advertising it across the network based on parameters like onboarding capacity, protocol version, and roles (e.g., a redbox). In some cases, a configuration-based approach is simpler to onboard and does not require multiple devices contending to be the trust anchor. A backup trust anchor node also can be configured for redundancy for initial onboarding.

At block 404, the network nodes probe for a trust anchor or trusted node. Each node needs to prove its identity and establish trust before joining the secure redundant network. For example, trust is established only with a trust anchor or a peer node that has established trust with the trust anchor. In one aspect, when a new node (also referred to as an onboarding node) tries to join the replication network, the onboarding node can send a multicast supervision frame to probe for a trusted node or trust anchor node. If there is a trusted node within the first hop of the onboarding node, the trusted node will respond directly to the new node and start the onboarding process. If there is no trusted node within the first hop, the supervision frame is forwarded until it reaches a trust anchor node.

At block 406, trust is established between the onboarding node and the trust anchor. In some aspects, the trust anchor may prove its identity to an onboarding node. For example, the trust anchor can perform a TPM remote attestation using a remote verification to validate the trust anchor's assertions (e.g., identity, platform information, etc.). In one example, the TPM remote attestation verifies and proves the identity and authenticity of the hardware and software executing on the hardware. In another example, in the case that a TPM is not available, the trust anchor can provide a certificate authority (CA) certificate that allows the onboarding node to independently validate.

As part of block 406, the onboarding node may also its identity to the trust anchor using, for example, a TPM remote attestation of the onboarding node or a CA certificate of the onboarding node. In this way, the onboarding node and the trust anchor provide a mutual trust based on a two-way validation. The onboarding node may send additional information in a frame to the trust anchor, such as a public key associated with the onboarding node.

At block 408, after the trust is established between the trust anchor and the onboarding node, the trust anchor will provide the redundancy network key to the onboarding node on unicast supervision frames. For example, the trust anchor may send the public RedNetKey and the private RedNetKey to the onboarding node in different frames. In one aspect, the trust anchor may encrypt or sign the content within the supervision frames with the public and private RedNetKey based on the public key provided by the onboarding node. This allows the onboarding node to validate the contents within the supervision frames based on its private key to ensure that the chain of trust is extended to the onboarding node.

Once the onboarding node has completed initial onboarding, its state changes to a trusted node. The trusted node and the trust anchor can now exchange supervision frames that are encrypted using the RedNetKey or include content signed by the RedNetKey without full encryption. In this case, the trust anchor has established a chain of trust to the trusted node and can defer onboarding of new nodes to reduce the load on the trust anchor.

At block 410, a management device updates the node table. In this case, the management device may be the trust anchor, may have configured the trust anchor, or may be configured as a control plane. The management device uses the node table 362 to manage and monitor the devices within the network and thereby ensure robust communication and fault tolerance. For example, the management device, using the node table, facilitates quick detection and recovery from link or device failures to enhance network reliability, redundancy, and performance.

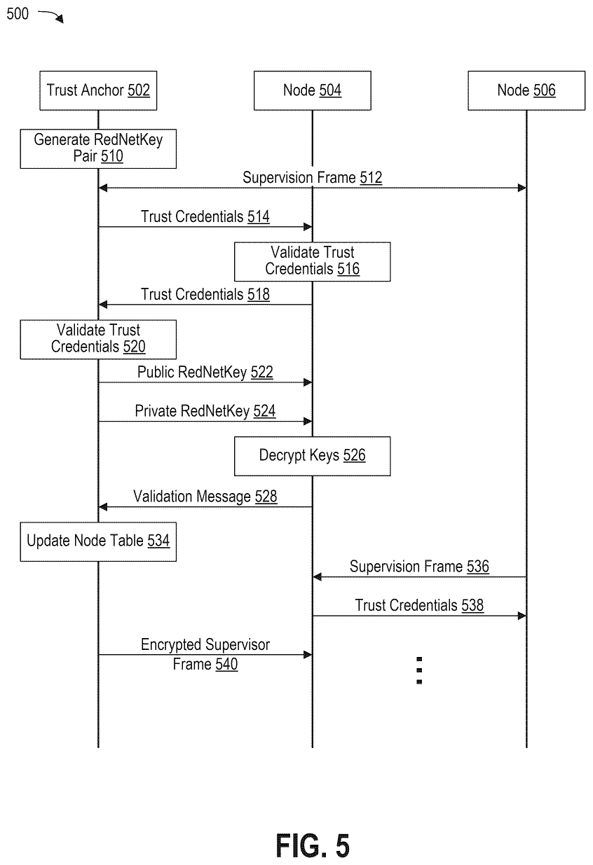

FIG. 5 is a sequence diagram 500 for preventing supervision frame injection attacks in replication networks in accordance with some aspects of the disclosure. In particular, a trust anchor 502 has been selected prior to the events in FIG. 5, and node 504 and node 506 are configured as part of a replication network. As noted above, there are no security precautions pertaining to supervision frames and a node could inject supervision frames to cause issues within the network. Accordingly, the sequence diagram 500 illustrates one example of establishing a chain of trust to nodes within the replication network for transmitting and receiving supervision frames. Other frames, such as frames replicated from an ingress to an egress, may not be encrypted or signed.

At block 510, the trust anchor 502 is configured to generate a redundancy network key at block 510, such as an asymmetric keypair. The node 504 is configured to multicast a supervision frame 512 requesting to onboard onto the replication network. For example, the trust anchor 502 and the node 504 are a single hop away from the node 504. In this case, the supervision frame includes content requesting access to the replication network. In some examples, the supervision frame can be received by the trust anchor 502 and content can be passed into the software layer (e.g., the anchor engine 354) for processing. In some cases, the functionality can be integrated into hardware processing layers (e.g., by the LRE 330 in FIG. 3).

The trust anchor 502 responds by sending trust credentials 514 to the node 504. For example, the trust credentials can be validated trust information associated with the trust anchor 502 including identification of various aspects of the trust anchor 502. As an example, the trust credentials can include operating system information, TPM information, firmware versions, and other information that identifies specific details of the trust anchor 502. At block 516, the node 504 is configured to validate the trust credentials. In one example, the node 504 validates the sending trust credentials 514 using a third-party attestation device, or other secure devices that the node 504 can confirm the authenticity of the information (e.g., a CA that issued a certificate in the sending trust credentials 514). If the node 504 does not validate the authenticity of the sending trust credentials 514, the node 504 may stop the onboarding process using the trust anchor 502.

In this case, the trust anchor 502 is presumed to be valid and the node 504 thereby sends its trust credentials 518 to the trust anchor 502. In some aspects, the trust credentials 518 can also include encryption information, such as a public key of the node 504. The trust anchor 502 validates the trust credentials 518 from the node 504 at block 520, which is presumed to be valid in this example. In response to validating the node 504, the trust anchor 502 establishes trust with the node 504 and may send a public redundancy network key 522 to the node 504. In some cases, the public redundancy network key 522 is encrypted with the public key from the node 504. The trust anchor 502 also sends a private redundancy network key 524 to the node 504 separately from the public redundancy network key 522.

At block 526, the node 504 decrypts the public redundancy network key 522 and the private redundancy network key 524 and stores these keys in a secure enclave or other protected medium. Non-limiting examples of a secure enclave include a TPM, a TAM, and so forth. In some aspects, the public redundancy network key 522 and the private redundancy network key 524 are always stored in a volatile medium to ensure that the chain of trust is revoked upon power cycling or other events to change the state of the node 504. For example, the public redundancy network key 522 and the private redundancy network key 524 may be stored in volatile memory of a TPM.

The node 504 may send a validation message 528 to the trust anchor 502 to indicate that the chain of trust is established. For example, the validation message can be encrypted using the public redundancy network key 522, allowing the trust anchor 502 to check the authenticity of the message. In response to validation message 528, the trust anchor 502 may update a node table at block 534 to include the trust anchor 502 as a node within the replication network. The trust anchor 502 may modify the replication network or wait for additional nodes to be onboarded before establishing the replication network.

The node 506 may multicast a supervision frame 536 to the node 504. In this case, the node 504 has established a chain of trust with the trust anchor 502 and may send trust credentials 538 (e.g., corresponding to trust credentials 518) to the node 506 to validate its identity and configuration to the node 506. In this way, the node 504 can extend the trust generated from the trust anchor 502 and authenticate other nodes such as the node 506, creating a hierarchy of trust and distributing information for securely encrypting supervision frames, preventing unauthorized network devices from injecting supervision frames into the network. For example, encrypted supervisor frame 540 can be provided to nodes to protect supervisor frames and prevent injection of unauthorized frames.

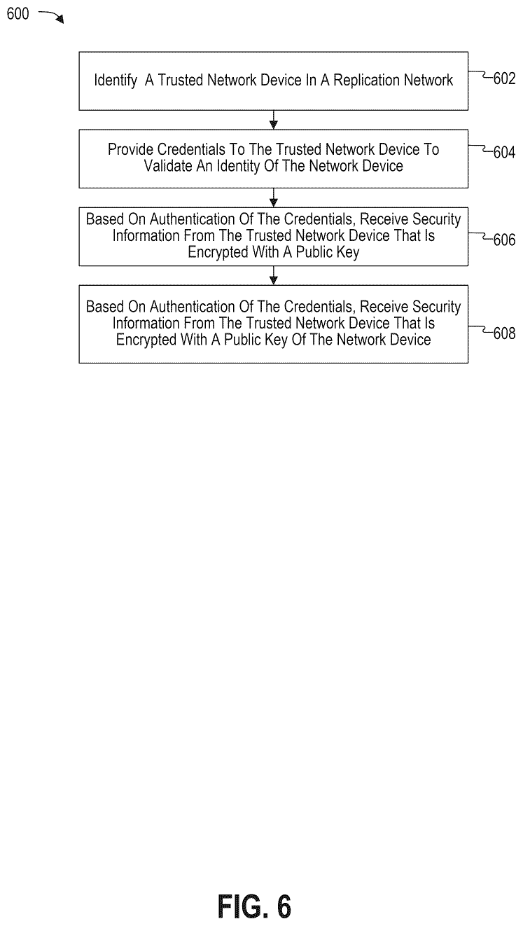

FIG. 6 illustrates an example method for preventing supervision frame injection attacks in replication networks in accordance with some aspects of the disclosure. As noted above, the method can be implemented at different layers (e.g., network layer, physical layer, application layers). For example, in some cases, the LRE 330 can be configured for the described method. The LRE can be configured as a hardware component, such as a functional programmable gate array (FPGA) or an application specific integrated circuit (ASIC). For example, the LRE can be designed using a hardware description language such as Very High-Speed Integrated Circuit (VHSIC) hardware description language (VHDL) or Verilog in accordance with some aspects of the disclosure.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence. Although a network device (e.g., using the system-on-chip (SoC) or a hardware component such as an FPGA or ASIC, etc.) is described as performing the method, this example is for descriptive purposes.

At block 602, the network device may identify a trusted network device in a replication network. The trusted network device comprises a trusted anchor that generates the security information or a peer network device that stores the security information from the trusted anchor. For example, the security information may include a public RedNetKey and a private RedNetKey.

In some aspects after block 602, the trusted anchor device may transmit trust credentials to the network device (e.g., in a supervision frame), which the network device may use to validate trust with respect to the trusted anchor device. For example, the network device may use a third-party attestation service to validate the authenticity of the information encrypted and the content contained within the trust credentials.

At block 604, the network device is configured to provide credentials to the trusted network device to validate the identity of the network device. In this case, the credentials may include a public encryption key of the network device, and the network device does not share the private encryption key. In one example, the network device may send remote attestation information provided to the network device based on a validation of software used by the network device with a third-party verification device. For example, after the network device trusts the trust anchor as noted above based on a third-party validation, the network device sends information to the trust anchor that can be used to establish bidirectional trust. However, as noted above, if the network device does not establish trust with the trusted anchor device, the network device may cease communication because the network could be compromised.

In another example, the network device may send a certificate generated by a CA. to the trusted network device that attests to the identity of the network device. The trusted network device verifies the validity of the certificate to determine that the network device is deemed trusted.

At block 606, the network device may, based on authentication of the credential at the trusted network device, receive security information from the trusted network device that is encrypted with a public key of the network device. In one example of block 606, the network device may receive a public security key of the replication network in a first message (e.g., the public RedNetKey) and receive a private security key (e.g., a private RedNetKey) of the replication network in a second message.

At block 608, the network device may transmit an onboarding supervision frame encrypted with or signed by the security information. In this case, the trusted network device knows the public encryption key specific to the network device and can decrypt information in the onboarding supervision frame that is encrypted with the private key. In some aspects, a management device of the replication network updates trusted peer information based on the onboarding supervision frame. For example, the management device may be the trusted network device but may be other devices in the network or other devices adjacent to the network, such as a control plane.

In one aspect, a network redundancy device may receive the onboarding supervision frame or other information (e.g., from the management device) and configure the network device to operate in one of a first link or a second link. The network redundancy device is configured to replicate frames and send frames on different paths (e.g., across different networks in a PRP network, or in different directions in a ring network) In some aspects, after the network device is onboarded, the network device may receive a multicast supervisor frame from a peer network device and then onboard the peer network device. For example, the network device may send, to the peer network device, a request to attestation of an identity of the peer network device and, in response to validating the identity of the peer network device, transmit the security information from the trusted network device. For example, the network device may transmit the private RedNetkey and the public RedNetKey in different frames to the peer network device.

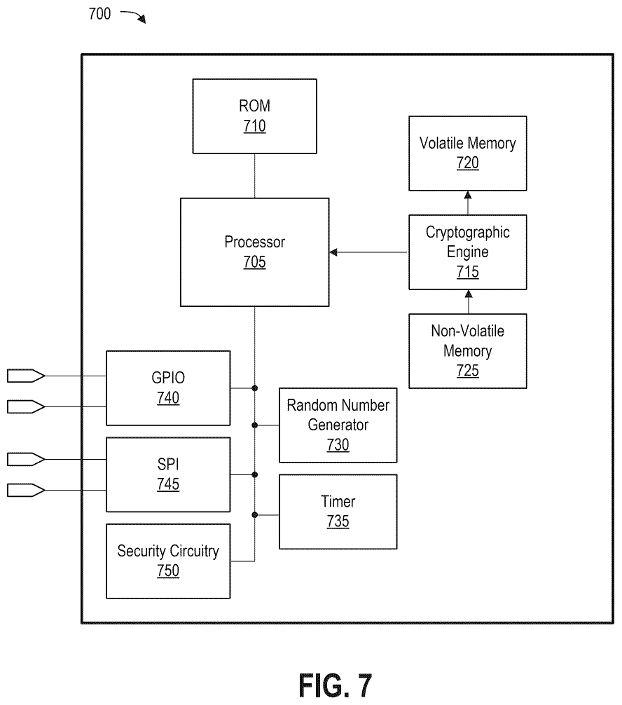

FIG. 7 illustrates an example block diagram of a TPM 700 in accordance with some aspects of the disclosure. The TPM 700 includes a processor 705 that cannot be accessed directly. The processor 705 is connected to a read only memory (ROM) program 710 that provides secure instructions to securely boot and operate the TPM 700.

The TPM 700 includes a cryptographic engine 715 that connects a volatile memory 720 (e.g., SRAM) and a non-volatile memory 725 (e.g., a flash memory) to the processor 705. The cryptographic engine 715 securely encrypts and decrypts data stored in either the volatile memory 720 or the non-volatile memory 725 and performs cryptographic hash functions and other iterative processes that can be performed by a dedicated hardware implementation. In the example illustrated in FIG. 7, the cryptographic engine 715 is placed in series with the volatile memory 720 or the non-volatile memory 725 to perform encryption and decryption before the data is received by the processor 705. In other examples, the cryptographic engine 715 may be placed in series so that the processor 705 fetches and stores encrypted data and calls the cryptographic engine 715 to decrypt or encrypt data directly within the processor 705. The volatile memory 720 and the non-volatile memory 725 are configured to be inaccessible outside of the TPM 700.

The TPM 700 also includes a random number generator (RNG) 730 that generates a sequence of numbers or symbols that cannot be reasonably predicted better than by a random chance. The RNG 730 can be implemented as a truly random hardware random-number generator to generate random numbers as a function of the current value of some physical environment attribute that is constantly changing in a manner that is practically impossible to model. The RNG 730 can also be a pseudorandom number generator and generates numbers that look random but are deterministic.

The TPM 700 also includes a timer 735 to perform timing functions in connection with various security functions (challenge/response) of the TPM $00. The TPM 700 also includes a general purpose input/output (GPIO) 740 for sending and receiving data. The TPM 700 also includes a serial peripheral interface (SPI) for sending and receiving data. In some cases, the SPI 745 can be configured in child mode that requires a parent SPI interface to provide instructions to control the communication interface.

The TPM 700 also includes security circuitry 750 to detect tampering and other anomalous events. For example, the security circuitry 750 may include voltage and temperature tampers, an active shield, and other physical security measures that would indicate that the TPM 700 is being physically altered. The security circuitry 750 cause the processor 705 to output information via GPIO 740 and SPI 745 to indicate that the TPM 700 was compromised and the TPM 700 cannot be trusted. The security circuitry 750 can also wipe sensitive data in a secure manner.

The TPM 700 is configured to perform power-on self-tests when booted or reset. First, the TPM 700 performs a self-test to verify the RNG 730 and secure hash algorithm (SHA) capabilities for secure boot operations. After self-test verification, the remaining tests verify the integrity of the remaining system components.

In addition, the TPM 700 can be configured in any number of devices that require a level of physical and digital security. For example, TPM 700 can be implemented by any device that requires physical and digital security (e.g., processors, logic circuits, networking equipment, mobile phones, tablet devices, flash memory devices, cryptographic authenticators, displays, printers, etc.).

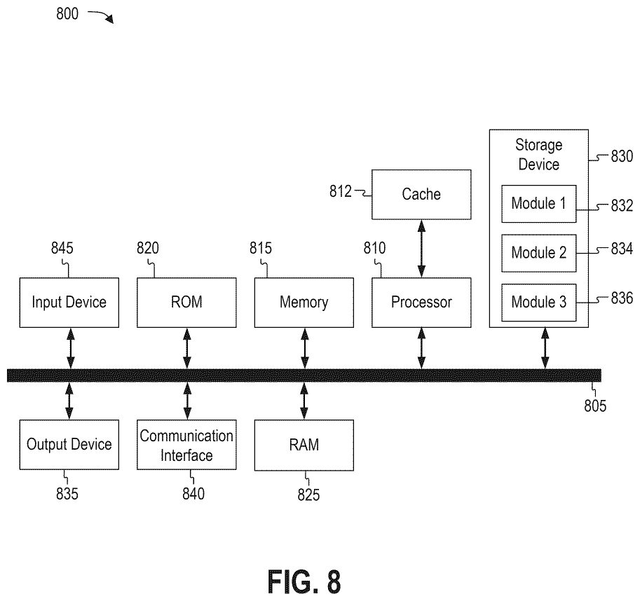

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 800 includes at least one processing unit (a central processing unit (CPU) or processor) 810 and connection 805 that couples various system components including system memory 815, such as ROM 820 and RAM 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 600, and/or other process described herein) may be performed by a computing device or apparatus. In one example, the method 600 can be performed by a computing device having a computing architecture of the computing system 800 shown in FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“&lt;”) and greater than (“&gt;”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
identifying, by a network device, a trusted network device in a replication network;
providing credentials to the trusted network device to validate an identity of the network device;
based on authentication of the credentials at the trusted network device, receiving security information from the trusted network device that is encrypted with a public key of the network device; and
transmitting an onboarding supervision frame encrypted with or signed by the security information, wherein a management device of the replication network updates a trusted peer information based on the onboarding supervision frame.

2. The method of claim 1, wherein the trusted network device comprises a trusted anchor that generates the security information or a peer network device that stores the security information from the trusted anchor.

3. The method of claim 1, wherein receiving the security information from the trusted network device comprises:
receiving a public security key of the replication network in a first message; and
receiving a private security key of the replication network in a second message.

4. The method of claim 1, wherein providing the credentials comprises:
sending remote attestation information provided to the network device based on a validation of software used by the network device with a third-party verification device.

5. The method of claim 1, wherein providing the credentials comprises:
sending a certificate generated by a certificate authority (CA) to the trusted network device, wherein the trusted network device verifies the validity of the certificate to determine that the network device is deemed trusted.

6. The method of claim 1, further comprising:
receiving a multicast supervisor frame from a peer network device;
sending to the peer network device, a request to attestation of an identity of the peer network device; and
in response to validating the identity of the peer network device, transmitting the security information from the trusted network device.

7. The method of claim 1, wherein a network redundancy device receives the onboarding supervision frame and configures the network device to operate in one of a first link or a second link.

8. A network device for preventing supervision frame injection attacks in replication networks, comprising:
at least one memory; and
at least one processor coupled to the at least one memory and configured to:
identify, by a network device, a trusted network device in a replication network;
provide credentials to the trusted network device to validate an identity of the network device;
based on authentication of the credentials at the trusted network device, receive security information from the trusted network device that is encrypted with a public key of the network device; and
transmit an onboarding supervision frame encrypted with or signed by the security information, wherein a management device of the replication network updates a trusted peer information based on the onboarding supervision frame.

9. The network device of claim 8, wherein the trusted network device comprises a trusted anchor that generates the security information or a peer network device that stores the security information from the trusted anchor.

10. The network device of claim 8, wherein the at least one processor is configured to:
receive a public security key of the replication network in a first message; and
receive a private security key of the replication network in a second message.

11. The network device of claim 8, wherein the at least one processor is configured to:
send remote attestation information provided to the network device based on a validation of software used by the network device with a third-party verification device.

12. The network device of claim 8, wherein the at least one processor is configured to:
send a certificate generated by a certificate authority (CA) to the trusted network device, wherein the trusted network device verifies the validity of the certificate to determine that the network device is deemed trusted.

13. The network device of claim 8, wherein the at least one processor is configured to:
receive a multicast supervisor frame from a peer network device;
send to the peer network device, a request to attestation of an identity of the peer network device; and
in response to validating the identity of the peer network device, transmit the security information from the trusted network device.

14. The network device of claim 8, wherein a network redundancy device receives the onboarding supervision frame and configures the network device to operate in one of a first link or a second link.

15. A non-transitory computer readable medium for preventing supervision frame injection attacks in replication networks, comprising:
a storage configured to store instructions; and
a processor configured to execute the instructions and cause the processor to:
identify, by a network device, a trusted network device in a replication network;
provide credentials to the trusted network device to validate an identity of the network device;
based on authentication of the credentials at the trusted network device, receive security information from the trusted network device that is encrypted with a public key of the network device; and
transmit an onboarding supervision frame encrypted with or signed by the security information, wherein a management device of the replication network updates a trusted peer information based on the onboarding supervision frame.

16. The non-transitory computer readable medium of claim 15, wherein the trusted network device comprises a trusted anchor that generates the security information or a peer network device that stores the security information from the trusted anchor.

17. The non-transitory computer readable medium of claim 15, wherein the processor is configured to execute the instructions and cause the processor to:
receive a public security key of the replication network in a first message; and
receive a private security key of the replication network in a second message.

18. The non-transitory computer readable medium of claim 15, wherein the processor is configured to execute the instructions and cause the processor to:
send remote attestation information provided to the network device based on a validation of software used by the network device with a third-party verification device.

19. The non-transitory computer readable medium of claim 15, wherein the processor is configured to execute the instructions and cause the processor to:
send a certificate generated by a certificate authority (CA) to the trusted network device, wherein the trusted network device verifies the validity of the certificate to determine that the network device is deemed trusted.

20. The non-transitory computer readable medium of claim 15, wherein the processor is configured to execute the instructions and cause the processor to:
receive a multicast supervisor frame from a peer network device;
send to the peer network device, a request to attestation of an identity of the peer network device; and
in response to validating the identity of the peer network device, transmit the security information from the trusted network device.
